(19) United States
(12) Patent Application Publication
(10) Pub. No.: US 2023/0119786 A1
(43) Pub. Date: Apr. 20, 2023

(54) METHOD AND APPARATUS FOR REALIZING QUANTUM OPERATION

(71) Applicant: Tsinghua University, Beijing (CN)

(72) Inventors: Luming DUAN, Beijing (CN); Haoxiang YANG, Beijing (CN)

(21) Appl. No.: 17/678,194

(22) Filed: Feb. 23, 2022

(30) Foreign Application Priority Data
Oct. 19, 2021 (CN) 202111215599.7

(51) Int. Cl. G02F 3/02; G06N 10/40

(52) U.S. Cl. CPC G02F 3/022; G06N 10/40

(57) ABSTRACT

Disclosed are a method and apparatus for realizing a quantum operation. According to embodiments of the present disclosure, an ion qubit containing a first set of long-lived energy levels and a second set of long-lived energy levels is selected, wherein each of the first set of long-lived energy levels and the second set of long-lived energy levels contains two or more than two sub-energy levels for qubit encoding; a second continuous-wave laser beam containing two frequency components, which is used for coherent transfer between different sets of long-lived energy levels and construction of a single-qubit gate and a two-qubit gate, is obtained by performing frequency adjustment on a first continuous-wave laser beam; parameter adjustment is performed on the second continuous-wave laser beam according to a quantum operation to be performed to obtain a corresponding laser beam for performing the quantum operation according to quantum operation to be performed.

### CROSS-REFERENCE TO RELATED APPLICATION

The present application claims priority to Chinese Patent Application No. 202111215599.7 filed to the CNIPA on Oct. 19, 2021, the content of which is incorporated herein by reference.

### TECHNICAL FIELD

The present disclosure relates to, but is not limited to, quantum computer technologies, in particular to a method and apparatus for realizing a quantum operation.

### BACKGROUND

A quantum computer is a device that uses quantum logic gates for general quantum computation. A basic logic unit of the quantum computer is composed of qubits complying principles of quantum mechanics, and the quantum computer can be constructed using a large number of interacting qubits which can be manipulated coherently. Compared with a classical computer, the quantum computer provides a significant speed-up when solving some specific problems. The quantum computer has a wide application prospect in future basic scientific research, quantum communication and cryptography, artificial intelligence, financial market simulation, climate change prediction and so on, and has attracted remarkable attention.

Using a trapped ion (or atom) qubit array various quantum logic gates with high fidelity can be realized under existing experimental conditions. A quantum logic gate (including a single-qubit gate and a two-qubit gate) is an essential operation in quantum computation. Ion qubits are excellent in key indicators for measuring the quantum computation performance, such as interaction controllability, long coherence time, high-fidelity quantum logic gates, and quantum error correction, and are one of the platforms that are most likely to realize the quantum computer. For ionic quantum computation, coherent transfer between ionic states is of great significance for scalable quantum computation. For the ion qubit with two or more than two set of long-lived energy levels, the ion quint is encoded at one set of the long-lived energy levels. When quantum operations on some qubits are performed, other qubits can be coherently transferred to another set of long-lived energy levels for protective storage, thus eliminating the crosstalk error.

In related technologies, a laser beam for constructing a quantum logic gate and a laser beam for implementing coherent transfer are different, which leads to complexity of a system and is not scalable.

### SUMMARY

The following is a summary of the subject matter described in detail herein. This summary is not intended to limit the protection scope of claims.

Embodiments of the present disclosure provide a method and apparatus for realizing a quantum operation, which can realize coherent transfer between qubit states and construction of as quantum logic gate through laser beams from a same source and simplify composition of a system.

An embodiment of the present disclosure provides a method for realizing a quantum operation, which includes: performing frequency adjustment on a first continuous-wave laser beam to obtain a second continuous-wave laser beam containing two frequency components; performing parameter adjustment on the second continuous-wave laser beam according to a quantum operation to be performed to obtain a laser beam for performing the quantum operation; and irradiating the obtained laser beam for performing the quantum operation on a qubit meeting a preset condition to realize the quantum operation; wherein the qubit includes an ion qubit; the ion qubit includes a first set of long-lived energy levels for the quantum operation and a second set of long-lived energy levels for the quantum operation; each of the first set of long-lived energy levels and the second set of long-lived energy levels contains two or more than two sun-energy levels for qubit encoding; the quantum operation includes coherent transfer between different sets of long-lived energy levels, construction of a single-qubit gate, and construction of a two-qubit gate.

In another aspect, an embodiment of the present disclosure further provides an apparatus for realizing a quantum operation, which includes a modulation unit, a parameter adjustment unit, and an irradiation unit; wherein the modulation unit is configured to perform frequency adjustment on a first continuous-wave laser beam to obtain a second continuous-wave laser beam containing two frequency components; the parameter adjustment unit is configured to perform parameter adjustment ort the second continuous-wave laser beam according to a quantum operation to be performed to obtain a laser beam for performing the quantum operation; and the irradiation unit is configured to irradiate the obtained laser beam for performing the quantum operation on a qubit meeting a preset condition to realize the quantum operation; wherein the qubit includes an ion qubit; the ion qubit includes a first set of long-lived energy levels for the quantum operation and a second set of long-lived energy levels for the quantum operation; each of the first set of long-lived energy levels and the second set of long-lived energy levels contains two or more than two sub-energy levels for qubit encoding; and the quantum operation includes coherent transfer between different sets of long-lived energy levels, construction of a single-qubit gate, and construction of a two-qubit gate.

A technical solution of the present disclosure includes: performing frequency adjustment on a first continuous-wave laser beam to obtain a second continuous-wave laser beam containing two frequency component; performing parameter adjustment on the second continuous-wave laser beam according to a quantum operation to be performed, to obtain a laser beam for performing the quantum operation; irradiating the obtained laser beam for performing the quantum operation on a qubit meeting a preset condition to realize the quantum operation; wherein the qubit includes an ion qubit; the ion qubit includes a first set of long-lived energy levels for the quantum operation and a second set of long-lived energy levels for the quantum operation; each of the first set of long-lived energy levels and the second set of long-lived energy levels contains two or more than two sub-energy levels for qubit encoding; and the quantum operation includes coherent transfer between different sets of long-lived energy levels, construction of a single-qubit gate, and construction of a two-qubit gate. According to the embodiments of the present disclosure, an ion qubit containing a first set of long-lived energy levels and a second set of long-lived energy levels is selected, each of the first set of long-lived energy levels and the second set of long-lived energy levels contains two or more than two sub-energy levels for qubit encoding; a second continuous-wave laser beam containing two frequency components, which is used for coherent transfer between different sets of long-lived energy levels and construction of a single-qubit gate and a two-qubit gate, is obtained by performing frequency adjustment on a first continuous-wave laser beam; parameter adjustment is performed on the second continuous-wave laser beam according to a quantum operation to be performed to obtain a corresponding laser beam for performing the quantum operation according to the quantum operation to be performed; thereby realizing coherent transfer between different sets of long-lived energy levels, a single-qubit gate, and a two-qubit gate through laser beams from a same source, and simplifying composition of a system.

Other features and advantages of the present disclosure will be described in the following specification, and in part will be obvious from the specification, or may be understood by implementing the present disclosure. Purposes and other advantages of the present disclosure may be realized and obtained through structures particularly pointed out in the specification, claims, and drawings.

### BRIEF DESCRIPTION OF DRAWINGS

The accompanying drawings are used for providing a further understanding of technical solutions of the present disclosure, and constitute a part of the specification. They are used for explaining the technical solutions of the present disclosure together with the embodiments of the present disclosure, and do not constitute limitations on the technical solutions of the present disclosure.

FIG. 1 is a flowchart of a method for realizing a quantum operation according to an embodiment of the present disclosure.

FIG. 2 is a schematic diagram of an ion qubit according to an embodiment of the present disclosure.

FIG. 3 is a schematic diagram of a frequency of a laser beam for realizing a single-qubit gate according to an embodiment of the present disclosure.

FIG. 4 is a structural block diagram of an apparatus for realizing a quantum operation according to an embodiment of the present disclosure.

FIG. 5 is a schematic diagram of an optical path of an application example of the present disclosure.

### DETAILED DESCRIPTION

In order to make the purposes, technical solutions, and advantages of the present disclosure clearer, the embodiments of the present disclosure will be described in detail below with reference to the accompanying drawings, it should be noted that the embodiments in the present disclosure and features in the embodiments may be arbitrarily combined with each other without conflict.

Acts shown in a flowchart of a drawing may be performed such as in a computer system with a set of computer-executable instructions. And, although a logical order is shown in a flowchart, in some cases, the acts shown or described may be performed in a different order from that here.

FIG. 1 is a flowchart of a method for realizing a quantum operation according to an embodiment of the present disclosure. As shown in FIG. 1, the method includes following acts 101-103.

In act 101, frequency adjustment is performed on a first continuous-wave laser beam to obtain a second continuous-wave laser beam containing two frequency components.

In some exemplary examples, the second continuous-wave laser beam may contain more than two frequency components. Two frequency components of the more than two frequency components may be used for quantum operation, other frequency components may be used for other operations, or may be unused. The present application is not limited thereto, in an exemplary example, frequency adjustment in the embodiment of the present disclosure includes phase modulation.

In act 102, parameter adjustment is performed on the second continuous-wave laser beam according to a quantum operation to be performed, to obtain a laser beam for performing the quantum operation.

In act 103, the obtained laser beam for performing the quantum operation is irradiated on a qubit meeting a preset condition to realize the quantum operation.

Herein, the qubit includes an ion qubit; the ion qubit includes a first set of long-lived energy levels for the quantum operation and a second set of long-lived energy levels for the quantum operation; each of the first set of long-lived energy levels and the second set of long-lived energy levels contains two or more than two sub-energy levels for qubit encoding; the quantum operation includes coherent transfer between different sets of long-lived energy levels, construction of a single-qubit gate, and construction of a two-qubit gate.

In the embodiment of the present disclosure, qubits are encoded on magnetic-insensitive clock states on the first set or second set of long-lived energy levels. In the embodiment of the present disclosure, the energy difference between the first set and second set of long-lived energy levels is larger than 20 GHz (giga Hertz).

The first set of long-lived energy levels and the second set of long-lived energy levels in the embodiment of the present disclosure include: an energy level having a lifetime longer than a first preset multiple of a time scale for quantum operations in an exemplary example, the first preset multiple may include 1000 or more. The first preset multiple may be determined and adjusted by those skilled in the art according to an application scenario and an implementation difficulty of a quantum operation. In an exemplary example, the first preset multiple of the time scale for the quantum operations may be set to 1 millisecond.

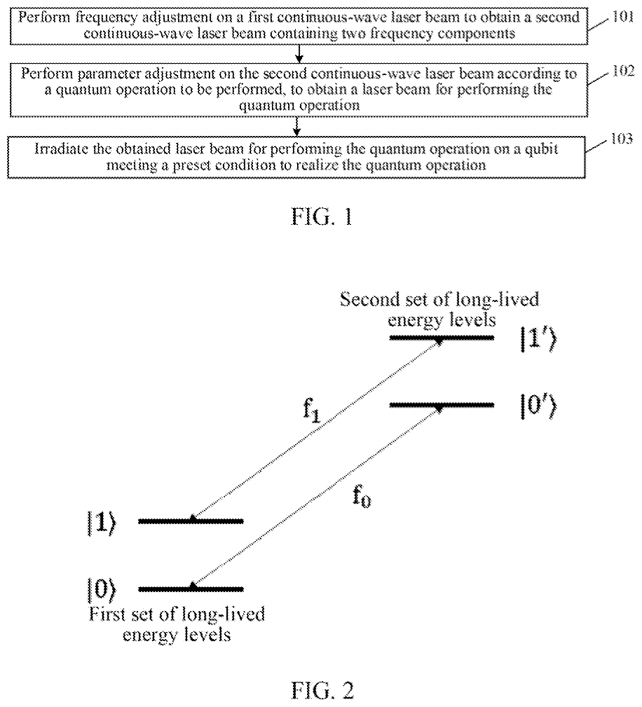

In an exemplary example, the performing frequency adjustment on the first continuous-wave laser beam according to the embodiment of the present disclosure includes: performing phase modulation on the first continuous-wave laser beam through an Electro-Optic Modulator (EOM) with a first driving frequency to obtain a second continuous-wave laser beam when a quantum operation to be performed is the coherent transfer between different sets of long-lived energy levels; wherein a frequency difference between two frequency components of the second continuous-wave laser beam is f₀−f₁, and f₀ represents an energy difference between |0 [symbol] and |0′ [symbol] ; f₁ represents an energy difference between |1 [symbol] and |1′ [symbol] ; {|0 [symbol] , |1 [symbol] } represents qubit basis states on the first set of long-lived energy levels, {|0′ [symbol] , |1′ [symbol] } represents qubit basis states on the second set of long-lived energy levels. In the context, we have set the plank constant h=1. FIG. 2 is a schematic diagram of an ion qubit according to an embodiment of the present disclosure. As shown in FIG. 2, each set of long-lived energy levels contains two qubit basis states.

In an exemplary example, the first driving frequency in the embodiment of the present disclosure includes (f₁−f₀)/2.

Tt should be noted that the first driving frequency in the embodiment of the present disclosure may also include another driving frequency that may be used for obtaining the above second continuous-wave laser beam.

In an exemplary example, the performing parameter adjustment on the second continuous-wave laser beam according to the quantum operation to be performed in the embodiment of the present disclosure includes: performing first adjustment on a central frequency of the second continuous-wave laser beam to let frequencies of the two frequency components of the second continuous-wave laser beam be f₀ and f₁ respectively when the quantum operation to be performed is the coherent transfer between different sets of long-lived energy levels.

It should be noted that according to the embodiment of the present disclosure, when the second continuous-wave laser beam contains a first frequency component and a second frequency component, the two frequency components of the second continuous-wave laser beam satisfy resonant transition conditions.

In an exemplary example, a central frequency of the second continuous-wave laser beam may be adjusted through an Acousto-Optic Modulator (AOM),

In an exemplary example, when the first driving frequency is

$$\frac{{f}_{1} - {f}_{0}}{2} ,$$

the second continuous-wave laser beam contains two frequency components with a frequency difference of (f₁−f₀). By adjusting the central frequency of the second continuous-wave laser beam through the AOM, the first frequency component may be f₀ and the second frequency component may be f₁. Therefore, the first frequency component drives resonant transition between |0 [symbol] and |0′ [symbol] and the second frequency component drives resonant transition between |1 [symbol] and |1′ [symbol] . When transition rates of |0 [symbol] ↔|0′ [symbol] transition and |1 [symbol] ↔|1′ [symbol] transition are equal, the two transitions will be completed at the same time, so that the coherence between the qubit basis states can be maintained.

In an exemplary example, the performing frequency adjustment on the first continuous-wave laser beam according to the embodiment of the present disclosure includes: performing phase modulation on the first continuous-wave laser beam through an EOM with a second driving frequency to obtain a second continuous-wave laser beam; wherein a frequency difference between the two frequency components is equal to fₕ, and fₕ represents an energy difference between qubit basis states on the first set of long-lived energy levels. FIG. 3 is a schematic diagram of a frequency of a laser beam realizing a single-qubit gate according to an embodiment of the present disclosure. As shown in FIG. 3, a frequency difference of two frequency components is equal to fₕ.

In an exemplary example, the second driving frequency in the embodiment of the present disclosure is equal to fₕ/2.

In an exemplary example, the performing parameter adjustment on the second continuous-wave laser beam according to the embodiment of the present disclosure includes: performing second adjustment on a central frequency and polarization of the second continuous-wave laser beam to let a transition rate of Raman transition between the qubit basis states on the first set of long-lived energy levels driven by the second continuous-wave laser beam be nonzero when the quantum operation to be performed is the construction of the single-qubit gate.

In an exemplary example, the performing parameter adjustment an the second continuous-wave laser beam according to the embodiment of the present disclosure includes: performing third adjustment on a central frequency and polarization of the second continuous-wave laser beam to let a transition rate of Raman transition between the qubit basis states on the first set of long-lived energy levels driven by the second continuous-wave laser beam be nonzero when the quantum operation to be performed is the construction of the two-qubit gate.

In an exemplary example, the performing frequency adjustment on the first continuous-wave laser beam according to the embodiment of the present disclosure includes: performing phase modulation on the first continuous-wave laser beam through an EOM with a third driving frequency to obtain the second continuous-wave laser beam containing two frequency components; wherein AC Stark shifts of the two qubit basis states on the first set of long-lived energy levels induced by the second continuous-wave laser beam are unequal when a central frequency of the second continuous-wave laser beam is a preset frequency and polarization of the second continuous-wave laser beam is preset polarization.

It should be noted that a value of the preset polarization in the embodiment of the present disclosure may be determined by those skilled in the art based on a relevant principle.

In an exemplary example, the performing parameter adjustment on the second continuous-wave laser beam according to the embodiment of the present disclosure includes: adjusting the central frequency of the second continuous-wave laser beam to the preset frequency and adjusting the polarization of the second continuous-wave laser beam to the preset polarization when the quantum operation to be performed is the construction of the two-qubit gate.

In an exemplary example, when the quantum operation to be performed is the construction of the two-qubit gate, according to the embodiment of the present disclosure the performing parameter adjustment on the second continuous-wave laser beam further includes: splitting the second continuous-wave laser beam into two beams; and adjusting central frequencies of the two second continuous-wave laser beams after splitting to let a difference between, a frequency difference between the two laser beams, and an eigenfrequency of a collective vibration mode excited during the construction of the two-qubit gates, be less than a preset multiple of an energy scale of the eigenfrequency.

In an exemplary example, the preset multiple of the embodiment of the present disclosure may include 0.1.

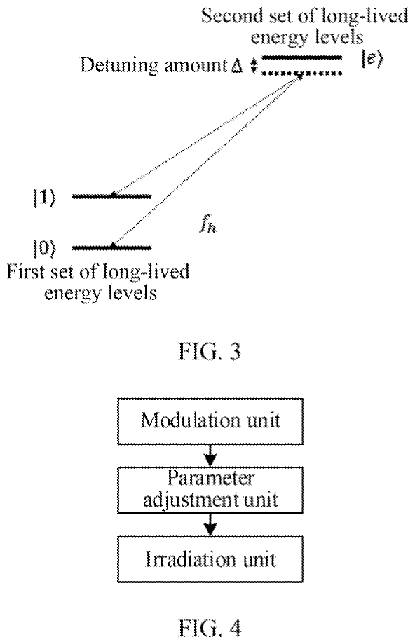

FIG. 4 is a structural block diagram of an apparatus for realizing a quantum operation according to an embodiment of the present disclosure. As shown in FIG. 4, a modulation unit, a parameter adjustment unit, and an irradiation unit. The modulation unit is configured to perform frequency adjustment on a first continuous-wave laser beam to obtain a second continuous-wave laser beam containing two frequency components. The parameter adjustment unit is configured to perform parameter adjustment on the second continuous-wave laser beam according to a quantum operation to be performed, to obtain a laser beam for performing the quantum operation. The irradiation unit is configured to irradiate the obtained laser beam for performing the quantum operation on a qubit meeting a preset condition to realize the quantum operation. Here the qubit includes an ion qubit; the ion qubit includes a first set of long-lived energy levels for the quantum operation and a second set of long-lived energy levels for the quantum operation; each of the first set of long-lived energy levels and the second set of long-lived energy levels contains two or more than two sub-energy levels for qubit encoding; the quantum operation includes coherent transfer between different sets of long-lived energy levels, construction of a single-qubit gate, and construction of a two-qubit gate.

According to the embodiment of the present disclosure, an ion qubit containing a first set of long-lived energy levels and a second set of long-lived energy levels is selected, each of the first set of long-lived energy levels and the second set of long-lived energy levels contains two or more than two sub-energy levels for qubit encoding; a second continuous-wave laser beam containing two frequency components, which is used for coherent transfer between different sets of long-lived energy levels and construction of a single-qubit gate and a two-qubit gate, is obtained by performing frequency adjustment on a first continuous-wave laser beam; parameter adjustment is performed on the second continuous-wave laser beam according to a quantum operation to be performed to obtain a corresponding laser beam for performing the quantum operation according to the quantum operation to be performed; thereby realizing coherent transfer between different sets of long-lived energy levels, a single-qubit gate, and a two-qubit gate through laser beams from a same source, and simplifying composition of a system.

In an exemplary example, the modulation unit of the embodiment of the present disclosure is configured to perform phase modulation on the first continuous-wave laser beam through an Electro-Optic Modulator (EOM) with a first driving frequency to obtain a second continuous-wave laser beam when a quantum operation to be performed is the coherent transfer between different sets of long-lived energy levels. Here a frequency difference between the two frequency components of the second continuous-wave laser beam is f₀−f₁, and f₀ represents an energy difference between |0 [symbol] and |0′ [symbol] ; f₁ represents an energy difference between |1 [symbol] and |1′ [symbol] ; {|0 [symbol] , |1 [symbol] } represents qubit basis states on the first set of long-lived energy levels, and {|0′ [symbol] , |1′ [symbol] } represents qubit basis states on the second set of long-lived energy levels.

In an exemplary example, the first driving frequency in the embodiment of the present disclosure includes (f₁−f₀)/2.

In an exemplary example, the parameter adjustment unit of the embodiment of the present disclosure is configured to perform first adjustment on a central frequency of the second continuous-wave laser beam to let frequencies of the two frequency components of the second continuous-wave laser beam are f₀ and f₁ respectively when the quantum operation to be performed is the coherent transfer between different sets of long-lived energy levels.

In an exemplary example, the modulation unit of the embodiment of the present disclosure is configured to perform phase modulation on the first continuous-wave laser beam through an EOM with a second driving frequency to obtain a second continuous-wave laser beam. Here a frequency difference between the two frequency components is equal to fₕ, and fₕ represents an energy difference between qubit basis states at a first set of long-lived energy levels.

In an exemplary example, the second driving frequency in the embodiment of the present disclosure is equal to fₕ/2.

In an exemplary example, the parameter adjustment unit of the embodiment of the present disclosure is configured to perform second adjustment on a central frequency and polarization of the second continuous-wave laser beam to let a transition rate of Raman transition between the qubit basis states on the first set of long-lived energy levels driven by the second continuous-wave laser beam be nonzero when the quantum operation to be performed is the construction of the single-qubit gate.

In an exemplary example, the parameter adjustment unit of the embodiment of the present disclosure is configured to perform third adjustment on a central frequency and polarization of the second continuous-wave laser beam to let a transition rate of Raman transition between the qubit basis states on the first set of long-lived energy levels driven by the second continuous-wave laser beam be nonzero when the quantum operation to be performed is the construction of the two-qubit gate.

In an exemplary example, the modulation unit of the embodiment of the present disclosure is configured to perform phase modulation on the first continuous-wave laser beam through an EOM with a third driving frequency to obtain a second continuous-wave laser beam containing two frequency components. Here AC Stark shifts of the two qubit basis states on the first set of long-lived energy levels induced by the second continuous-wave laser beam are unequal when a central frequency of the second continuous-wave laser beam is a preset frequency and polarization of the second continuous-wave laser beam is preset polarization.

In an exemplary example, the parameter adjustment unit of the embodiment of the present disclosure is configured to adjust a central frequency of the second continuous-wave laser beam to the preset frequency and adjust the polarization of the second continuous-wave laser beam to the preset polarization when the quantum operation to be performed is the construction of the two-qubit gate.

In an exemplary example, the parameter adjustment unit of the embodiment of the present disclosure is configured to split the second continuous-wave laser beam into two beams; and adjust central frequencies of the two second continuous-wave laser beams after splitting to let a difference between, a frequency difference between the two laser beams, and an eigenfrequency of a collective vibration mode excited during the construction of the two-qubit gates, be less than a preset multiple of an energy scale of the eigenfrequency.

The embodiments of the present disclosure are briefly described below through application examples, which are only used for illustrating the embodiments of the present disclosure and are not used for limiting the scope of protection of the present disclosure.

### Application Examples

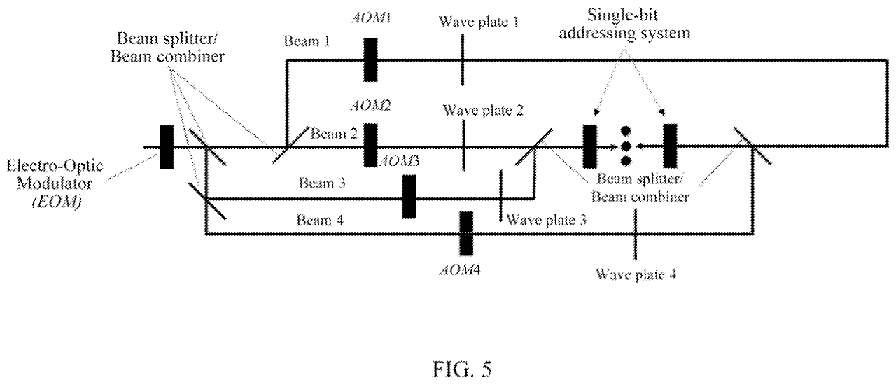

FIG. 5 is a schematic diagram of an optical path for realizing a quantum operation in an application example of the present disclosure. As shown in FIG. 5, the quantum operation is realized by laser beams from a same source. In FIG. 5, phase modulation is performed on a first continuous-wave laser beam using an Electro-Optic Modulator (EOM) to obtain a second continuous-wave laser beam containing two frequency components. The second continuous-wave laser beam is split into four laser beams, i.e., beam 1, beam 2, beam 3, and beam 4, by using a beam splitter. Beam 1 is used for coherent transfer between different sets of long-lived energy levels, beam 2 is used for constructing a single-qubit gate; beam 3 and beam 4 are used for constructing, a two-cubit gale, and beam 3 and beam 4 irradiate on a qubit from different directions. In the application example of the present disclosure, a central frequency and a power of each laser beam are adjusted using an AOM respectively, and polarization of each laser beam is adjusted using a wave plate respectively; a driving frequency of the Electro-Optic Modulator, a driving frequency and a power of the AOM, and an angle of the wave plate are adjusted according to the quantum operation to be performed to realize a corresponding quantum operation. Here the angle of the wave plate is preset and does not need dynamic adjustment. For example, when the quantum operation to be performed is coherent transfer between different sets of long-lived energy levels, the driving frequency of the EOM is set to be a first driving frequency (f₀−f₁)/2, and a driving frequency of an AOM1 is adjusted to let frequencies of two frequency components in the second continuous-wave laser beam be f₀ and f₁ respectively. Beams 2, 3, and 4 are turned off through an AOM2, an AOM 3, and an AOM4, so that only beam 1 is finally irradiated on the qubit. Qubit state transition may be realized by controlling irradiation time using the AOM1. When the quantum operation to be performed is the construction of a single-qubit gate, the driving frequency of the EOM is set to be a second driving frequency fₕ/2, a driving frequency of the AOM2 is adjusted to let a transition rate of Raman transition between the qubit basis states on the first set of long-lived energy levels driven by the second continuous-wave laser beam be nonzero, and Raman transition of the qubit between the two qubit basis state energy levels of the first set of long-lived energy levels is realized by controlling irradiation time using the AOM2, that is, the single-qubit gate is realized. When implementing the single-qubit gate, beams 1, 3, and 4 need to be turned off by using the AOM1, the AOM3, and the AOM4. When the quantum operation to be performed is the construction of a two-qubit gate, the driving frequency of the EOM is set to be fₕ/2, driving frequencies of the AOM3 and the AOM4 are adjusted to let a transition rate of Raman transition between the qubit basis states on the first set of long-lived energy levels driven by the second continuous-wave laser beam be nonzero; or the driving frequency of the EOM and the driving frequencies of the AOM3 and the AOM4 are adjusted to let light shifts caused by the second continuous-wave laser beam on the two qubit basis states on the first set of long-lived energy levels be unequal, and the driving frequencies of the AOM3 and the AOM4 are adjusted to let a difference between central frequencies of the beam 3 and the beam 4 be close to an eigenfrequency of a collective vibration mode excited during the construction of the two-qubit gate. The two-qubit gate can be realized by controlling irradiation time of the beam 3 and the beam 4 using the AOM3 and the AOM4. When implementing the two-qubit gate, the beam 1 and the beam 2 need to be turned off using the AOM1 and the AOM2.

In the application example of the present disclosure, by dynamically adjusting a driving frequency of an EOM, a driving frequency and a driving power of an AOM, coherent transfer between different sets of long-lived energy levels, a single-qubit gate, and a two-qubit gate are realized by using laser beams from a same source, thus reducing complexity of a system.

It can be understood by those of ordinary skill in the art that all or some of the acts in the methods disclosed above, functional modules/units in the systems and apparatuses disclosed above may be implemented as a software, a firmware, a hardware, and an appropriate combination thereof. In a hardware implementation mode, a division between functional modules/units mentioned in the above description does not necessarily correspond to a division of physical components; for example, a physical component may have multiple functions, or a function or act may be cooperatively performed by several physical components. Some or all of the components may be implemented as software executed by a processor, such as a Digital Signal Processor or a microprocessor, or as hardware, or as an integrated circuit, such as an Application Specific Integrated Circuit. Such software may be distributed on a computer-readable medium, which may include a computer storage medium (or a non-transitory medium) and a communication medium (or a transitory medium). As well known to those of ordinary skill in the art, the term “computer storage medium” includes a volatile, nonvolatile, removable, and non-removable medium implemented in any method or technology for storing information (such as computer readable instructions, a data structure, a program module, or other data). A computer storage medium includes but is not limited to a Random Access Memory (RAM), a Read Only Memory (ROM), an Electrically Erasable Programmable Read-Only Memory (EEPROM), a flash memory or another memory technology, a CD-ROM, a Digital Versatile Disk (DVD), or another optical disk storage, a magnetic box, a magnetic tape, a magnetic disk storage, or another magnetic storage apparatus, or any other medium that may be configured to store desired information and may be accessed by a computer. Furthermore, it is well known to those of ordinary skill in the art that a communication medium generally contains computer readable instructions, a data structure, a program module, or other data in a modulated data signal such as a carrier wave or another transmission mechanism, and may include any information delivery medium.

1. A method for realizing a quantum operation, comprising:
performing frequency adjustment on a first continuous-wave laser beam to obtain a second continuous-wave laser beam containing at least two frequency components; wherein two frequency components of the at least two frequency components are used for quantum operation;
performing parameter adjustment on the second continuous-wave laser beam according to a quantum operation to be performed, to obtain a laser beam for performing the quantum operation; and
irradiating the obtained laser beam for performing the quantum operation on a qubit meeting a preset condition to realize the quantum operation;
wherein the qubit comprises an ion qubit; the ion qubit comprises a first set of long-lived energy levels for the quantum operation and a second set of long-lived energy levels for the quantum operation; each of the first set of long-lived energy levels and the second set of long-lived energy levels contains two or more than two sub-energy levels for qubit encoding; and the quantum operation comprises coherent transfer between different sets of long-lived energy levels, construction of a single-qubit gate, and construction of a two-qubit gate.

2. The method according to claim 1, wherein the performing frequency adjustment on the first continuous-wave laser beam comprises:
performing phase modulation on the first continuous-wave laser beam through an Electro-Optic Modulator (EOM) with a first driving frequency to obtain the second continuous-wave laser beam when the quantum operation to be performed is the coherent transfer between different sets of long-lived energy levels;
wherein a frequency difference between the two frequency components of the second continuous-wave laser beam is f₀−f₁, f₀ represents an energy difference between |0 [symbol] and |0′ [symbol] ; f₁ represents an energy difference between |1 [symbol] and |1′ [symbol] ; {|0 [symbol] , |1 [symbol] } represents qubit basis states on the first set of long-lived energy levels, and {|0′ [symbol] , |1′ [symbol] } represents qubit basis states on the second set of long-lived energy levels.

3. The method according to claim 2, ⁻wherein the first driving frequency comprises (f₁−f₀)/2.

4. The method according to claim 2, wherein the performing parameter adjustment on the second continuous-wave laser beam comprises:
performing first adjustment on a central frequency of the second continuous-wave laser beam to let frequencies of the two frequency components of the second continuous-wave laser beam be f₀ and f₁ respectively when the quantum operation to be performed is the coherent transfer between different sets of long-lived energy levels.

5. The method according to claim 1, wherein the performing frequency adjustment on the first continuous-wave laser beam comprises:
performing phase modulation on the first continuous-wave laser beam through an Electro-Optic Modulator (EOM) with a second driving frequency to obtain the second continuous-wave laser beam;
wherein a frequency difference between the two frequency components is equal to fₕ, and fₕ represents an energy difference between qubit basis states on the first set of long-lived energy levels.

6. The method according to claim 5. wherein the second driving frequency is equal to fₕ/2.

7. The method according to claim 5, the performing parameter adjustment on the second continuous-wave laser beam comprises:
performing second adjustment on a central frequency and polarization of the second continuous-wave laser beam to let a transition rate of Raman transition between the qubit basis states on the first set of long-lived enemy levels driven by the second continuous-wave laser beam be nonzero when the quantum operation to be performed is the construction of the single-qubit gate.

8. The method according to claim 5, the performing parameter adjustment on the second continuous-wave laser beam comprises:
performing third adjustment on a central frequency and polarization of the second continuous-wave laser beam to let a transition rate of Raman transition between the qubit basis states on the first set of long-lived energy levels driven by the second continuous-wave laser beam be nonzero when the quantum operation to be performed is the construction of the two-qubit gate.

9. The method according to claim 1, wherein the performing frequency adjustment on the first continuous-wave laser beam comprises:
performing phase modulation on the first continuous wave laser beam through an Electro-Optic Modulator (EOM) with a third driving frequency to obtain the second continuous-wave laser beam containing the two frequency components;
wherein AC Stark shifts of the two qubit basis states on the first set of long-lived energy levels induced by the second continuous-wave laser beam are unequal when a central frequency of the second continuous-wave laser beam is a preset frequency and polarization of the second continuous-wave laser beam is preset polarization.

10. The method according to claim 9, the performing parameter adjustment on the second continuous-wave laser beam comprises:
adjusting the central frequency of the second continuous-wave laser beam to the preset frequency and adjusting the polarization of the second continuous-wave laser beam to the preset polarization when the quantum operation to be performed is the construction of the two-qubit gate.

11. The method according to claim 8, wherein the performing parameter adjustment on the second continuous-wave laser beam further comprises:
splitting the second continuous-wave laser bean into two beams; and
adjusting central frequencies of the two second continuous-wave laser beams after splitting to let a difference between, a frequency difference between the two laser beams, and an eigenfrequency of a collective vibration mode excited during the construction of the two-qubit gates, be less than a preset multiple of an energy scale of the eigenfrequency.

12. The method according to claim 3, wherein the performing parameter adjustment on the second continuous-wave laser beam comprises:
performing first adjustment on a central frequency of the second continuous-wave laser beam to let frequencies of the two frequency components of the second continuous-wave laser beam be f₀ and f₁ respectively when the quantum operation to be performed is the coherent transfer between different sets of long-lived energy levels.

13. The method according to claim 6, the performing parameter adjustment on the second continuous-wave laser beam comprises:
performing second adjustment on a central frequency and polarization of the second continuous-wave laser beam to let a transition rate of Raman transition between the qubit basis states on the first set of long-lived energy levels driven by the second continuous-wave laser beam be nonzero when the quantum operation to be performed is the construction of the single-qubit gate.

14. The method according to claim 6, the performing parameter adjustment on the second continuous-wave laser beam comprises:
performing third adjustment on a central frequency and polarization of the second continuous-wave laser beam to let a transition rate of Raman transition between the qubit basis states on the first set of long-lived energy levels driven by the second continuous-wave laser beam be nonzero when the quantum operation to be performed is the construction of the two-qubit gate.

15. The method according to claim 14, wherein the performing parameter adjustment on the second continuous-wave laser beam further comprises:
splitting the second continuous-wave laser beam into two beams; and
adjusting central frequencies of the two second continuous-wave laser beams after splitting to let a difference between, a frequency difference between the two laser beams, and an eigenfrequency of a collective vibration mode excited during the construction of the two-qubit gates, be less than a preset multiple of an energy scale of the eigenfrequency.

16. The method according to claim 10, wherein the performing parameter adjustment on the second continuous-wave laser beam further comprises:
splitting the second continuous-wave laser beam into two beams; and
adjusting central frequencies of the two second continuous-wave laser beams after splitting to let a difference between, a frequency difference between the two laser beams, and an eigenfrequency of a collective vibration mode excited during the construction of the two-qubit gates, be less than a preset multiple of an energy scale of the eigenfrequency.

17. An apparatus for realizing a quantum operation, comprising: a modulation unit, a parameter adjustment unit, and an irradiation unit, which are hardware units; wherein
the modulation unit is configured to perform frequency adjustment on a first continuous-wave laser beam to obtain a second continuous-wave laser beam containing two frequency components;
the parameter adjustment unit is configured to perform parameter adjustment on the second continuous-wave laser beam according to a quantum operation to be performed, to obtain a laser beam for performing the quantum operation; and
the irradiation unit is configured to irradiate the obtained laser beam for performing the quantum operation on a qubit meeting a preset condition to realize the quantum operation;
wherein the qubit comprises an ion qubit; the ion qubit comprises a first set of long-lived energy levels for the quantum operation and a second set of long-lived energy levels for the quantum operation; each of the first set of long-lived energy levels and the second set of long-lived energy levels contains two or more than two sub-energy levels for qubit encoding; and the quantum operation comprises coherent transfer between different sets of long-lived energy levels, construction of a single-qubit gate, and construction of a two-qubit gate.
